(19) United States
(12) Patent Application Publication
(10) Pub. No.: US 2023/0368635 A1
(43) Pub. Date: Nov. 16, 2023

(54) Method and system for contextual notification

(71) Applicant: Elemental Machines, Inc., Cambridge, MA (US)

(72) Inventors: Ian Harding, Wells, Somerset (GB); Sridhar Iyengar, Salem, NH (US); Casey Peters, Caldwell, NJ (US)

(73) Assignee: Elemental Machines, Inc., Cambridge, MA (US)

(21) Appl. No.: 18/026,990

(22) PCT Filed: Sep. 20, 2021
(86) PCT No.: PCT/US2021/051098

§ 371 Date: Mar. 17, 2023

Related U.S. Application Data
(60) Provisional application No. 63/081,033, filed on Sep. 21, 2020.

(51) Int. Cl. G08B 21/18; G06N 5/025

(52) U.S. Cl. CPC G08B 21/182; G06N 5/025

(57) ABSTRACT

Determining, generating, and issuing a contextual alert message to a user regarding an alert condition of a process system is provided. Described is determining variable data from a sensor associated with a process system, transmitting a first set of variable data from the sensor to a server and using the server to develop an alert classification model using the first set of variable data, where the alert classification model contains contextual information about an alert condition of the process system, transmitting a second set of data from the sensor to the server and using the server to compare the second set of data to a threshold value to determine if the process system is in an alert condition or approaching an alert condition.

### RELATED APPLICATIONS AND PRIORITY

This application claims the benefit of U.S. Prov. App. Ser. No. 63/081,033 filed on Sep. 21, 2020, which is incorporated herein by reference for all purposes.

### TECHNICAL FIELD

Embodiments described herein generally relate to computer network and related operations. More particularly, embodiments described herein relate to providing methods and devices for determining, generating, and issuing a contextual alert message regarding an alert condition of a process system

### BACKGROUND

The Internet of Things (IOT) has been a rapidly adopted technology over the last few years and has become especially important and critical in industrial applications, so much so that the term IIOT has emerged to refer to “Industrial IOT”. Generally speaking, IOT refers to devices, mechanical and/or electronic machines that are capable of at least some computation and associated system of software and networks that are able to transfer data over a network without requiring regular human interaction. Typically, IOT devices comprise a sensor, a microprocessor, and a connectivity module. The connectivity module connects the IOT device with a network, and may be “wireless” (using, e.g., WiFi, Bluetooth, Bluetooth Low Energy, RF, Zigbee, LoRa, cellular, 2G cellular, 3G cellular, 4G cellular, 5G cellular, and the like) or “wired” (using Ethernet, USB, serial, RS232, RS485, and the like).

In the early part of 2020, the COVID-19 pandemic forced many companies to shut down for extended periods of time, increasing the need for and reliance on IOT technologies to enable remote monitoring of companies' operations and facilities. Even after companies started opening up, they were still being run with fewer staff, with only essential staff being permitted on site and/or with limited on-site access, or with staggered staffing, all in an attempt to enforce social distancing. Industries that rely on in-person activity have been particularly hard hit, such as manufacturing, restaurants, retail shopping, grocery stores, hospitals, clinics, pharmacies, biotech companies, pharmaceutical companies, materials science companies, chemical companies, petrochemical companies, contract research organizations, research labs, research and development (R&D) labs, and the like.

One of the ways that IOT has been able to help is by monitoring critical assets and facilities that cannot be easily or regularly monitored in-person. Examples of such assets and facilities include, but are not limited to: Environmentally-controlled machines and instruments such as refrigerators, freezers, ovens, hotplates, incubators, and/or vending machines, etc.; Environmentally-controlled spaces such as walk-in freezers, walk-in cold rooms, cleanrooms and clean areas (including those specified by the ISO 14644 family of standard and the ISO 14698 family of standard), vivariums, saunas, greenhouses, and/or server rooms and data centers, etc.; Machinery including motors, turbines, and/or centrifuges etc.; analytical instrumentation including nuclear magnetic resonance (NMR) spectroscopy machines, magnetic resonance imaging (MRI) machines, mass spectrometers, and/or high performance liquid chromatography (HPLC) machines and systems, etc. among many others.

Such assets and facilities, and the processes which are associated and/or dependent on them, may be collectively called “Process Systems”. A common scenario is for these Process Systems to be monitored via an IOT device comprising a sensor that is responsive to at least one variable or parameter that is appropriate for the application. Non-limiting examples of variables or parameters include: temperature; intensity of electromagnetic radiation at at-least one frequency, including visible spectrum, infrared spectrum, ultraviolet spectrum, RF frequencies, etc; light; concentration of gas (e.g. CO₂, O₂); concentration of dissolved gas; pH; motion, including acceleration, velocity, and speed; intensity of sound at at-least one frequency; air pressure; absolute humidity and relative humidity; air quality (e.g. particle count, VOC); power consumption (e.g. voltage, AC current, DC current, or combinations thereof). It should be appreciated that other variable or parameters may be monitored by an IOT device that comprises a sensor that is responsive to that particular variable or parameter.

The variables listed above can be monitored for a variety of applications, systems and/or devices including, but not limited to: monitoring temperature in refrigerators, freezers, walk-in cold rooms, vivariums, manufacturing environments, ovens, etc.; monitoring temperature, humidity, and/or gas concentrations such as carbon dioxide and oxygen in cell-culture incubators; monitoring the power usage of machines and instruments like centrifuges, MRI machines, NMR machines, ovens, heaters, heating, ventilation, and air conditioning (HVAC) systems; monitoring air quality including VOC levels (volatile organic compounds), and/or particulate count in cleanrooms, office spaces, homes, and environments; monitoring vibration and/or motion of machines including generators, motors, die presses, turbines, robots, conveyer belts, and generally machines that have moving parts; monitoring one or more variable inside controlled environments, such as freezers, refrigerators, incubators, ovens, rooms, greenhouses, animal housings, vivariums, warehouses, shipping containers, shipping vehicles such as cars, vans, trucks, trains, airplanes, ships.

There are many sensors and instruments that can readily measure these and other variables of interest as a function of time. Exemplary sensors and instruments include, but are not limited to: thermocouple, thermistor, resistance temperature detector (RTD) for temperature, such as those supplied by Omega Engineering Inc.; photodiodes, photosensors, charge-coupled device (CCD) cameras for optical wavelengths of the EM spectrum including visible, infrared, and ultraviolet spectra; optical and electrochemical sensors for gas concentrations, such as those supplied by Alpha Sense and City Technology Ltd.; dissolved gas sensors; pH meters such as those supplied by Hanna Instruments, Omega Engineering Inc., and Cole-Parmer; motion sensors such as accelerometers supplied by Analog Devices, Omega Engineering Inc., STMicroelectronics; sound sensors such as those supplied by Vesper Mems; air pressure sensors; and/or humidity sensors.

Sensors like the ones above may be used to monitor different Process Systems to ensure proper operation and/or compliance with regulations. For example, a freezer may be deemed to be in proper operation when the temperature is within a certain range such as between −85C to −75C, or an incubator may be deemed to be operating properly if the humidity is between 95% and 100% or its carbon dioxide concentration is between 4% and 6%, or a vivarium housing animals may be deemed to be operating in a compliant manner if the temperature is between 23C and 27C and the humidity is between 30% and 60%. It should be appreciated that proper operation and/or compliance with regulations may be uniquely defined for each Process System without departing from the scope of the invention.

A notification or message may be issued when a Process System is deemed not to be operating in a desirable manner (e.g. not operating properly or not operating in a compliant manner). In such situations, the Process System can be said to be in an “alert” state. Proper operation of Process Systems can thus be determined by monitoring one or more than one variable of interest over time and checking to see if the variable is within a range of values, is above a threshold, is below a threshold, or is outside of a range of values for some defined period of time. The aforementioned ranges, thresholds, and time periods may be predefined or may be defined dynamically based on historical data. For example in: (a) an implementation, a method of determining if a Process System is in an alert state is if one or more values of a sensor or group of sensors is outside of a given range for a minimum period of time; and/or (b) in another implementation, a method of determining if a Process System is in an alert state is if at least one sensor reading satisfies at least one pre-determined condition, wherein the predetermined condition may be: an absolute condition; a relative condition; and/or a time-varying condition.

Once it has been determined that a Process System is in an alert state, a notification or message may be issued in many ways, including: sending an email; sending a text or SMS message; utilizing the native alert mechanism on a smart phone (e.g. Apple iPhone or Android phone); sending an electronic message or signal to a computing device (computer, tablet, smart phone, smart watch, etc.); and/or initiating a visual and/or audible alert, such as lighting up a light source or sounding an audible alarm, whether locally or at a remote monitoring location.

Furthermore, the message may comprise recommendations for actions that the user can take. Non-limiting examples include: scheduling calibration or maintenance; and/or suggesting that a user use a different machine, asset, or instrument for a particular task, for example: the incubator that has your cells may be damaged—it is recommended that you move your cells to a different incubator; and/or “the freezer where you store your samples experiences a lot of door opening events and therefore is our of temperature rage frequently—consider moving your samples.”

In a non-limiting example, when a freezer's temperature is above a threshold (for example, −70C) for some predefined period of time (for example, 10 minutes), that Process System is in an alert state. In this case, a temperature sensor is monitoring the freezer's temperature, and once the temperature has been above −70C for at least 10 minutes, an alert message is sent to a user via a text message, email, and/or phone call.

Many alerting and monitoring system on the market today operate in this manner, including systems from Monnit, Rees Scientific, and XiltriX. The problem with this current way of issuing notifications is that there is no context as to why the system entered into an alert state. Notifications are generally issued to inform the recipient that a system is currently in an alert state, but there is no information provided as to why the alert state came to be or if the situation is improving or worsening. This is especially true in the present working conditions caused by the COVID-19 pandemic (in 2020) whereby staff and employees are much more working from home and are not present on site in their company's facilities to inspect and check on why the alert state may have occurred. Further, access to facilities resources may be extremely limited, so context is increasingly important in order to deploy the correct resources to address the root of the problem rather than simply reacting the alert state.

Accordingly, there is a strong need to provide context regarding alerts and/or to indicate potential root cause(s) as to why a system entered into an alert state and optionally information as to the current status of the system.

### BRIEF SUMMARY OF THE INVENTION

In a first embodiment, the present invention provides a method for determining, generating, and issuing a contextual alert message to a user regarding an alert condition of a process system. The method includes the steps of:
(i) determining variable data from a sensor associated with a process system;
(ii) transmitting a first set of variable data from the sensor to a server and using the server to develop an alert classification model using the first set of variable data, wherein the alert classification model contains contextual information about an alert condition of the process system;
(iii) transmitting a second set of data from the sensor to the server and using the server to compare the second set of data to a threshold value to determine if the process system is in an alert condition or approaching an alert condition;
wherein if the process system is determined in step (iii) to be in an alert condition or approaching an alert condition, then:
(iv) using the server to compare the second set of data to the alert classification model to determine contextual information about the alert condition of the process system; and
(v) using the server to generate and issue a contextual alert message to a user regarding the alert condition of the process system,
thereby determining, generating, and issuing a contextual alert message to a user regarding an alert condition of a process system.

In a second embodiment, the present invention provides a method for determining and generating a contextual alert message regarding an alert condition of a process system. The method comprising the steps of:
(i) using variable data from a sensor associated with a process system to develop an alert classification model that contains contextual information about an alert condition of the process system;
(ii) using variable data from the sensor if the process system is in an alert condition;
wherein if the process system is determined in step (ii) to be in an alert condition, then:
(iii) comparing the variable data received in step (ii) to the alert classification model developed in step (i) to determine contextual information about the alert condition of the process system; and
(v) generating a contextual alert message regarding the alert condition of the process system,
thereby determining and generating a contextual alert message regarding an alert condition of a process system.

In a third embodiment, the present invention provides apparatuses for determining and generating and/or issuing a predictive contextual alert message to a user regarding a predicted alert condition of a process system. The apparatuses comprise programmed circuitry having instructions for performing the steps of any of the methods described herein and optionally a server component comprising instructions for performing server associated steps of the described methods.

### BRIEF DESCRIPTION OF THE DRAWINGS

FIGS. 1 to 7 show representative temperature traces over time and associated device status configurations and/or alert conditions in accordance with embodiments of the present invention.

FIGS. 8A to 8D show representative devices status traces and operations thereon in accordance with embodiments of the present invention.

FIGS. 9 and 10 show representative temperature traces over time and associated device status configurations and/or alert condition triggering and clearing in accordance with embodiments of the present invention.

FIGS. 11 to 17 and 22 show respective block diagrams of sensor data flow and/or information and/or decision trees in creation of workflows and/or device status/alert modeling in accordance with embodiments of the present invention.

FIGS. 18 to 21 show representative user interface representations of IoT device implementation and/or contextual alerting in accordance with embodiments of the present invention.

### DETAILED DESCRIPTION

The present invention provides solutions to the above-described problems in the art. Described herein are methods, systems, and/or computer readable media and/or instructions for determining and/or providing context regarding alerts and/or to indicate potential root cause(s) as to why a system entered an alert state and optionally information as to the current status of the system.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation are described. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment. One skilled in the art will understand that there a numerous alternative variations that fall within the scope of the following disclosure. Reference to one embodiment or another embodiment is understood to be within the context of the disclosure and reference or embodiments may be combined in any fashion to arrive at a combination of separately disclosed features and that any of these combinations fall within the present disclosure.

### Definitions:

A “process system” as used herein is not limited and can include any system or process where monitoring and/or tracking thereof is desired or required. Non-limiting examples includes devices or equipment such as freezers, refrigerators, ovens, incubators and/or other laboratory and/or manufacturing facility equipment. In other embodiments, a process system may be a combination of devices or equipment described above and/or a series of steps or subroutine performed using any of these types of devices. Unless the context is specifically limiting the such process systems can include an analytical instrument, measurement instrument, laboratory instrument, process instrument, manufacturing instrument, analytical equipment, measurement equipment, laboratory equipment, process equipment, manufacturing equipment, testing instrument/equipment, medical instrument/equipment, and facility management instrument/equipment, etc. These instruments and equipment are well known in the art and are not particularly limited herein.

The phrase Internet of Things (IoT) refers to physical objects, devices or “things” embedded with electronics, software and the ability to connect to the Internet or other top level server system etc. The connectivity permits the implementation of systems that monitor and control an activity. By way of example, multiple sensors in a manufacturing plant or laboratory may be controlled (turned on/off or throttled) based on a number of factors such as the desired power level, temperature, and the operation of devices within the loop. Thus, not only can single sensors (e.g. a light or temperature sensor) or actuators (e.g. a switch) be controlled in this way. Collections of sensors and actuators may be designed to function as a unit, where inter-device communication is operationally beneficial or necessary.

### Exemplary Methods of the Invention:

In one embodiment, the present invention provides a method for determining, generating, and issuing a contextual alert message to a user regarding an alert condition of a process system. The method comprising the following steps, which include:
(i) determining variable data from a sensor associated with a process system;
(ii) transmitting a first set of variable data from the sensor to a server and using the server to develop an alert classification model using the first set of variable data, wherein the alert classification model contains contextual information about an alert condition of the process system;
(iii) transmitting a second set of data from the sensor to the server and using the server to compare the second set of data to a threshold value to determine if the process system is in an alert condition or approaching an alert condition;
wherein if the process system is determined in step (iii) to be in an alert condition or approaching an alert condition, then:
(iv) using the server to compare the second set of data to the alert classification model to determine contextual information about the alert condition of the process system; and
(v) using the server to generate and issue a contextual alert message to a user regarding the alert condition of the process system,
thereby determining, generating, and issuing a contextual alert message to a user regarding an alert condition of a process system.

In a further embodiment, the present invention provides a method for determining and generating a contextual alert message regarding an alert condition of a process system. In this embodiment, the method includes at least the following steps of:
(i) using variable data from a sensor associated with a process system to develop an alert classification model that contains contextual information about an alert condition of the process system;
(ii) using variable data from the sensor if the process system is in an alert condition;
wherein if the process system is determined in step (ii) to be in an alert condition, then:
(iii) comparing the variable data received in step (ii) to the alert classification model developed in step (i) to determine contextual information about the alert condition of the process system; and
(v) generating a contextual alert message regarding the alert condition of the process system,
thereby determining and generating a contextual alert message regarding an alert condition of a process system.

In preferred embodiments, the contextual alert information comprises the alert condition and contextual information about the alert condition. The contextual information can be for example information such as why/when/how the alert condition was/will be reached; the root cause/timing of the alert condition; whether the process system is currently in/out of the alert condition; the current variable data of sensor measurement; the trajectory of the variable data; and data or information received or interpreted from other sensors. In alternative embodiments, the contextual alert information can include information such as a root cause message based on classification of primary root causes of process systems alerts and current process conditions which then are subsequently combined.

The variable data is preferably received and used by the server from a first sensor and optionally one or more additional sensors in developing the alert classification model and in determining the contextual information about the alert condition. The sensors are not particularly limited herein and can include sensors and/or sensor units coupled with or in communication with a sensor control unit which are either or both programmed with logic or instructions to receive and/or transfer sensor data to the application service and/or data storage device. In preferred embodiments, the sensor and/or sensor unit measures environmental data selected from the group consisting of temperature, humidity, light intensity, light wavelengths, vibration, gas concentration, air pressure, volatile organic compounds (VOC) concentration, particulate level, air pollution level, calibration information, user information, and equipment use information.

The sensor is preferably associated with the process system and is preferably an environmental variable sensor positioned to determine variable environmental data about or within the process system. Several different environmental factors can be measured using the various embodiments described herein. The word ‘Environment’ can be for example: the area where an instrument (lab or manufacturing equipment where measurement or other related data is obtained from); a laboratory or part of a laboratory space, a cold room, an animal house, a manufacturing floor, a greenhouse, a weather station; the area surrounding a chemical or ingredient being measured, or involved in the preparation of samples being measured, such as a reagent bottle (as measured by a miniaturized sensor or array of sensors, a ‘smart lid’ etc.), any storage container (grain silo, fermentation tank, refrigerator, freezer, etc.). The environmental factors (e.g. measured environmental parameters) can be, for example any of the following: temperature, humidity, atmospheric pressure, gas composition (overall, or specific to certain components of interest such as Volatile Organic Compounds (VOCs), ammonia, carbon monoxide, carbon dioxide, oxygen, or any other molecule for which sensors are available) light intensity (overall, or specific to a window of wavelengths—red, green, blue, or otherwise filtered to be sensitive only to a range of frequencies useful to the application, such as blue-UV for light-sensitive chemistry, or near infra-red, red and blue for plant growth) sound intensity (overall, or specific to a window of frequencies), motion, changes in magnetic strength or orientation etc. Another environment factor related to the instrument measurement data that can be measured by environmental sensing units is “whom took the measurement” and/or the “Time of measurement” from the laboratory/manufacturing facility equipment or “duration of a process step”. Such a measured factor can give a measure of the environment representative of conditions such as when using the instrument and/or inside a reagent container immediately before use. Further such a measured factor can give duration data (i.e. difference between times of measurements of other process steps) and this can also be determined from measured and recorded time points. This factor can be determined by any known methods of determining time or duration of time. In the alternative this factor can be determined by: a change of state in measuring equipment (e.g. change in weight recorded by a balance, motion detected by motion sensor (such as an accelerometer, gyroscope, software-based gyroscope) fitted to portable equipment or reagent containers etc.). In the alternative it simply can be determined and input by the operator of the equipment.

The choice of what environmental factor(s) to measure can be guided by relevance to the measurement (known or suspected by instrument manufacturer, research and supervisory staff) and availability of sensors (both commercially and the subset installed by an institution). The location of sensors needs to be adequate to represent the local environment but this may not mean close spatially; for example, atmospheric pressure across an entire floor of a building may be equal if there are no positive-pressure areas like clean rooms or negative-pressure areas like biohazard containment areas, and so an atmospheric pressure sensor somewhere on that floor can often be used to supply environmental pressure data relevant to the entire floor. In contrast, storage humidity may require a far more local sensor within a reagent container. Handling humidity may be recorded by a nearby humidity environmental sensor, but if there are no sources of water vapour addition (humidifiers, hot water baths etc.) or extraction (dehumidifiers, areas of water condensation) a more remote humidity sensor can be used; however, relative humidity varies with temperature and so corrections may be needed for temperature differences, using dew point or water vapour pressure as a constant point for correction.

The contextual alert message provides an indication as to why/how/when etc. the alert was generated and can contain any or all of the sensor data described above. In preferred embodiments, the alert message is a predictive contextual alert message. Such message will preferably contain prediction information regarding a future alert condition of the process system or that the process system is on a trajectory to achieve and/or is approaching a future alert condition.

To increase utility, the process system can be located in a facility selected from the group consisting of: a laboratory, medical facility, and a manufacturing facility.

### Exemplary Apparatuses of the Invention:

In further embodiments the present invention provides apparatuses (such IoT devices or IoT systems etc. optionally coupled with a top level or cloud server components) for determining and generating and/or issuing a predictive contextual alert message to a user regarding a predicted alert condition of a process system. The apparatuses include programmed circuitry (such as computing and/or computer and/or electronic infrastructure, communication devices, relays etc.) including instructions for performing the steps of any of the methods described herein. For example the apparatus of the present invention may include local IoT device or infrastructure in communication with a processing system such as web server and/or application server via the internet through a local router or wireless network. The processing system comprising logic and /or other computer readable instructions to perform the process steps described herein and to provide contextual alerts as described etc.

### EXAMPLES

The following non-limiting examples are provided to illustrate concepts and embodiments of the principles of the invention.

### Example 1: Monitoring Freezer Temperature

### Root Cause

In this non-limiting example, temperature monitoring of a freezer is considered. In freezer monitoring (and in general for controlled environment monitoring) it is possible for a notification, message, or alert to be generated and sent when the temperature crosses a threshold and remains there for a set period of time. Some systems also inform the user once the temperature has returned back to the desired range and remains there for some period of time. This is useful since the user is notified that the excursion is no longer an issue.

Whilst this type of notification system is useful and helpful for initial alerting, there may be many different reasons or root causes as to why the temperature may have crossed the threshold. Furthermore, such a basic system cannot inform the user if the temperature may be returning back towards the desired range (and only informs the user after it has returned). This basic system provides no insight or explanation as to why the temperature variation may have occurred. Thus, it is useful to have a system that can also inform the user of potential root causes for the initial excursion, the current state of the Process System during the excursion event, and an indication that the excursion event is over if the system returns back to its desired normal operating range.

Table 1 below lists some common root causes for the temperature of a freezer to have an excursion and increase above a predefined threshold and associated status. Red dotted lines in the Figures indicate the time at which an alert is triggered. Green dotted lines in the Figures indicate the time at which the alert is cleared (i.e., when the temperature of the freezer has returned back below the threshold). The table below shows that for each root cause that triggered an alert, there may be more than one state that the freezer is in (current freezer status) when the alert or notification message is sent to the user.

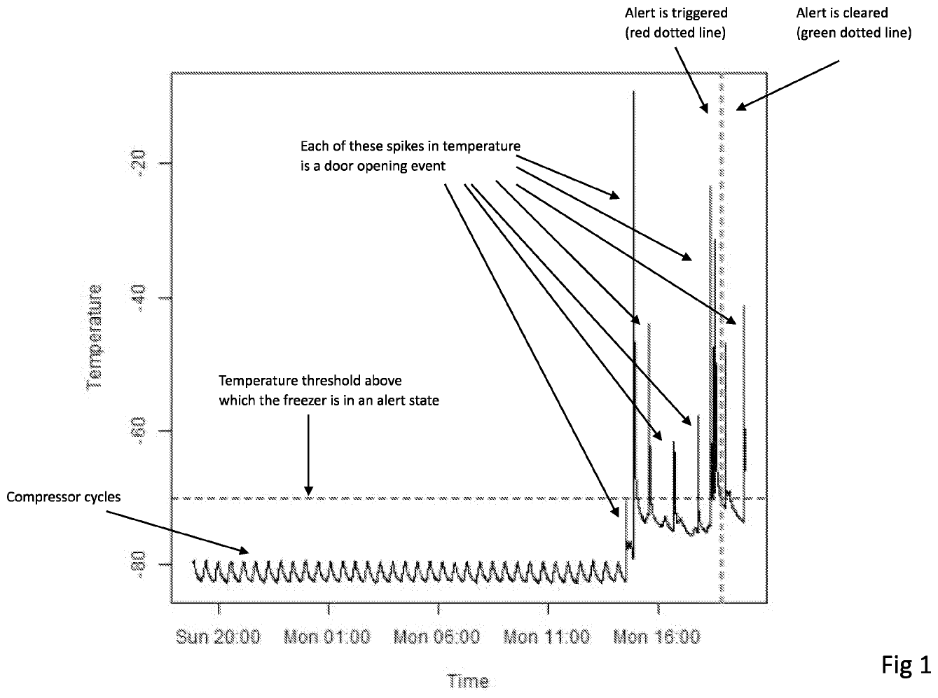

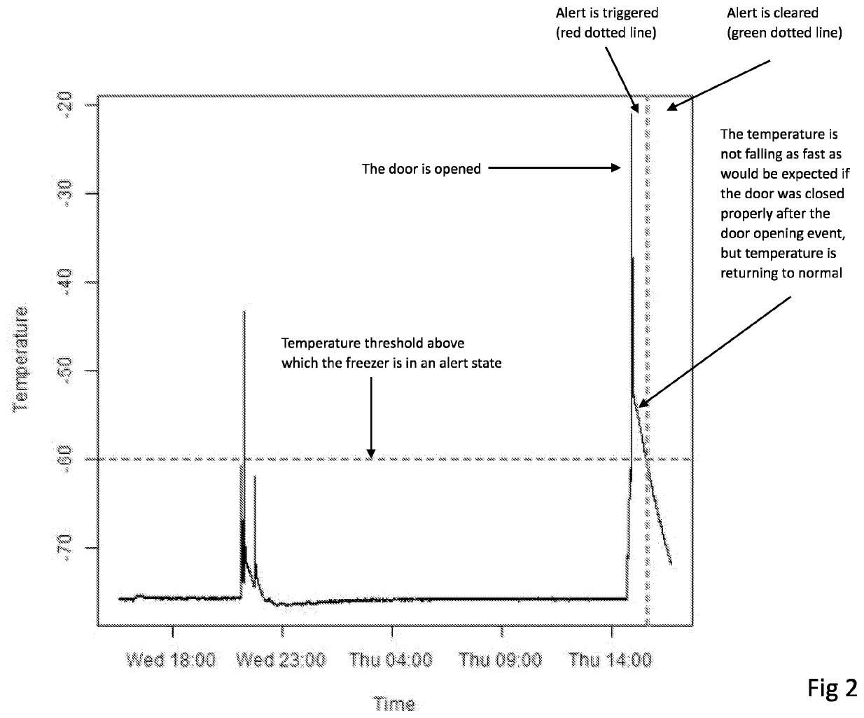

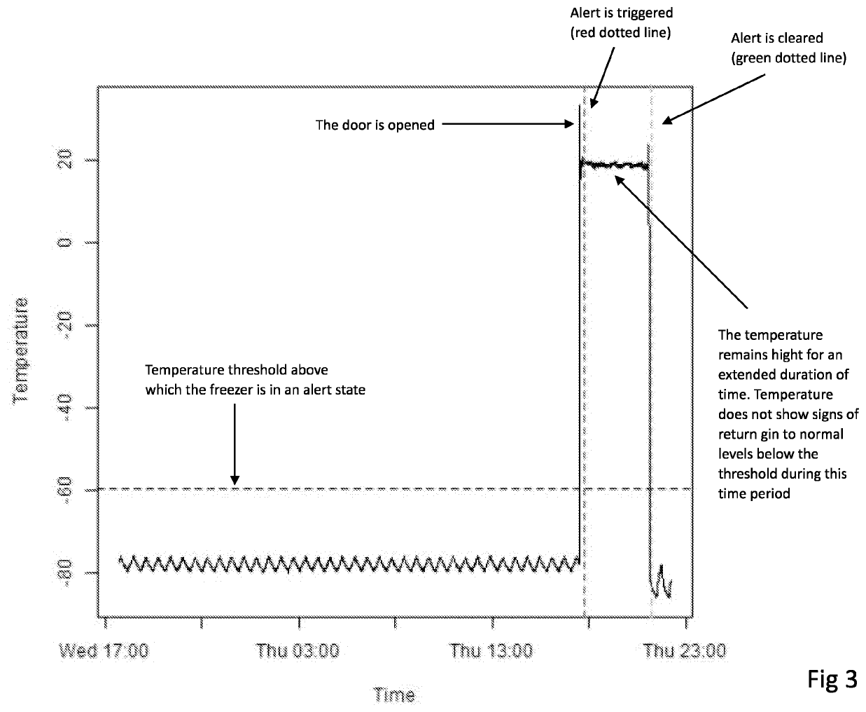

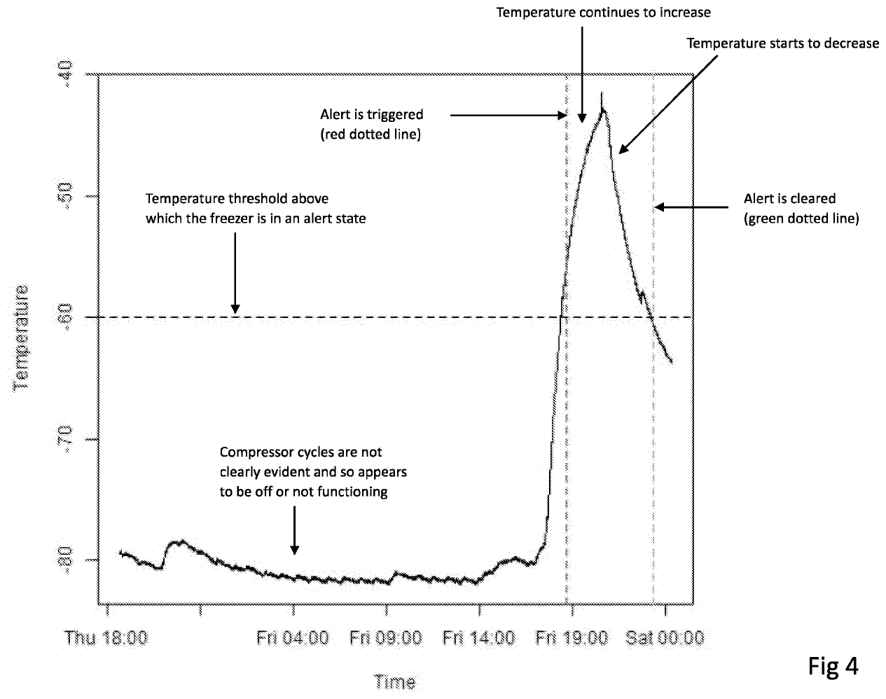

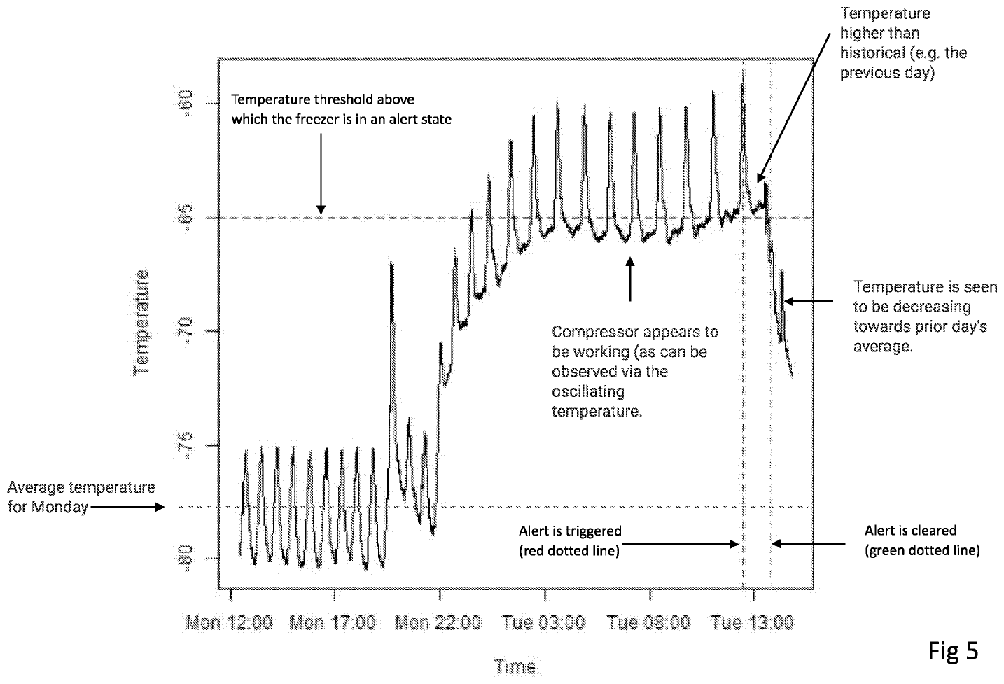

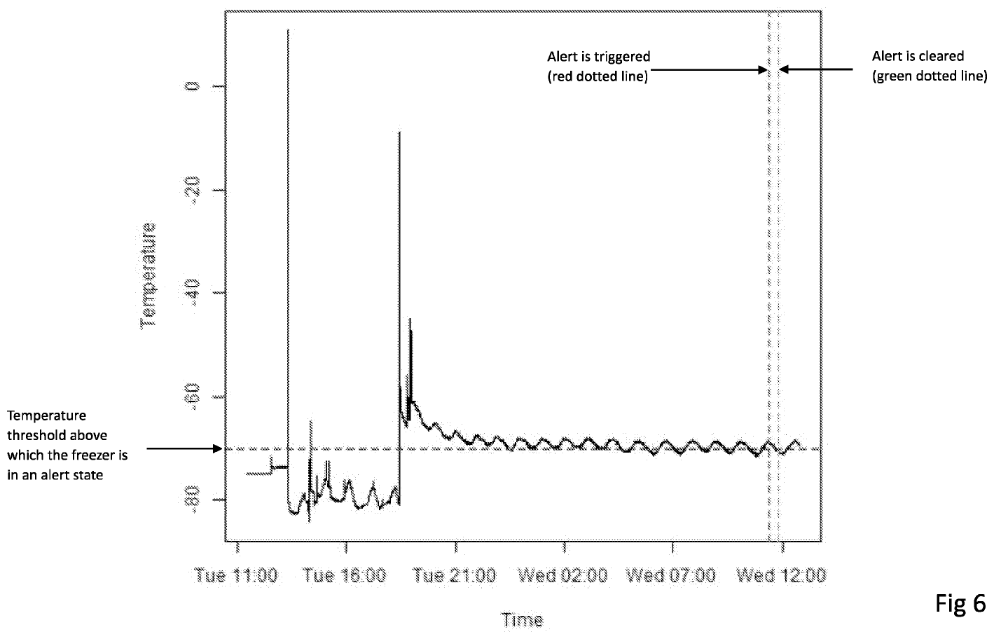

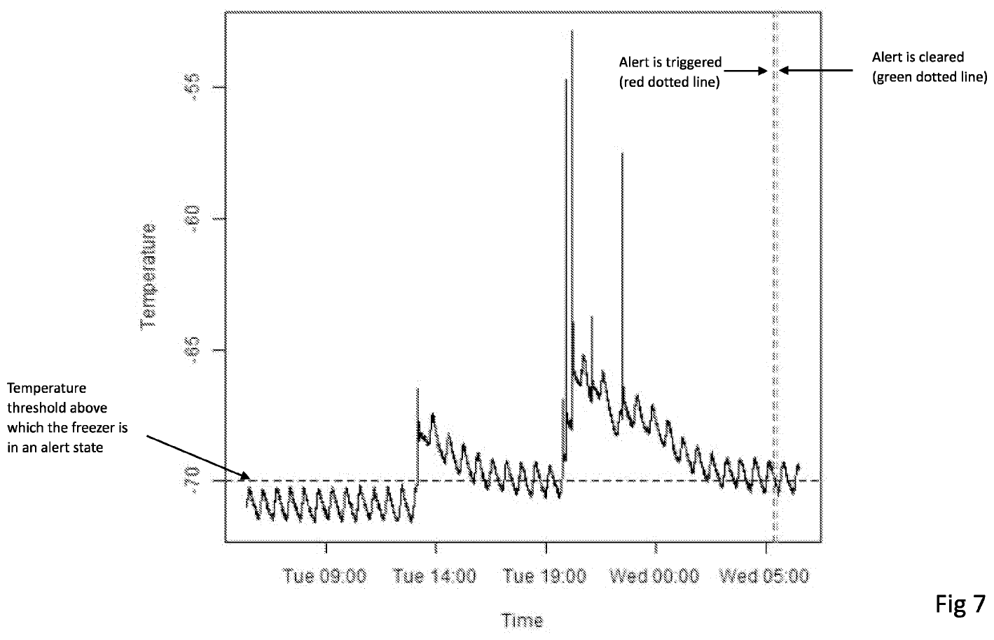

TABLE 1

| Root Cause State(s) | Current Freezer | |
|---|---|---|
| to Trigger Alert | Status | FIG. |
| Multiple door openings in a short period of | Door recently opened | FIG. 1 |
| time: The freezer's compressor | | |
| does not have enough time to cool | | |
| the interior down below the alert threshold | | |
| before the next opening of the door | | |
| causes the temperature to rise again. | | |
| Single Extended Door Open: The | Door is now closed and | FIG. 2 |
| freezer door is opened and kept open | temperature returning to | |
| for an extended period of time. This | normal. | |
| usually occurs when a user is | Door is still open (this may | FIG. 3 |
| searching for an item, or when the | also be caused by the user | |
| door may not have been closed fully | performing a manual defrost | |
| after it was opened. | of the freezer as part of | |
| | routine maintenance). Note | |
| | this status pertains to the | |
| | time shortly after the alert | |
| | (time shown in red), which | |
| | is eventually cleared | |
| | (time shown in green). | |
| Compressor appears to be off: The door | Temperature is increasing during | FIG. 4 |
| is closed after a door open event, but | a portion of the excursion and | |
| the temperature continues to increase | then is decreasing for a portion of | |
| and then starts to decrease. | the excursion | |
| Compressor on, but struggling to | Temperature higher than | FIG. 5 |
| maintain low temperature: | historical (e.g. the previous | |
| Compressor is not working | day). Compressor appears | |
| efficiently, or there may be some leak | to be working (as can be | |
| that is hindering the compressor's | observed via the oscillating | |
| ability to lower the temperature. | temperature. Temperature is | |
| | seen to be decreasing | |
| | towards prior day's average. | |
| Compressor on, but struggling | Compressor is on and | FIG. 6 |
| to maintain low temperature. | temperature slowly | |
| | decreasing. | |
| Door open multiple | Compressor on, temperature | FIG. 7 |
| times: Compressor on, but struggling | is slowly | |
| to lower temperature. | decreasing. | |

These Figures show examples of how different root causes can cause the temperature of the freezer to increase above a predefined threshold. As can be seen, it is useful to also know and understand these root causes when an alert message is received so that the user understands the context around the alert. Furthermore, in this example, there are two notification messages that are sent: the first one is when the temperature increases above the alert threshold (shown in red in FIGS. 1-7), and the second notification message is when the temperature decreases below the alert threshold (shown in green in FIGS. 1-7). It is also useful to inform the user about the current state of the freezer temperature when an alert notification is issued in addition to just the root cause. For example, it is useful to know if the compressor is working or not so that a repair may be initiated, or if the temperature is continuing to increase or if it is starting to decrease. Example scenarios are shown in the table above and also in FIGS. 1-7.

In the embodiments described herein, methods and apparatuses are described for providing contextual information related to an alert condition. As described above, an alert condition is a condition where a Process System is in a state that is deemed to be in a state that warrants a notification to be generated and/or sent to a recipient, such as a user or a computing device. The embodiments relate inter alia to any and all of the following scenarios: Providing contextual information when an alert condition is reached; Providing contextual information after an alert condition is reached; Providing contextual information during the time in which a Process System is in an alert state; Providing contextual information when a Process System has exited an alert state; Providing contextual information after a Process System has exited an alert state; Providing contextual information before a Process system has entered an alert state. Such a scenario is possible when conditions are monitored and analyzed at regular or irregular time intervals, continuously, semi-continuously, periodically, or generally at predefined intervals (which can be either fixed duration intervals or intervals of different durations) during times when a Process System is not in an alert state. In this manner, conditions that indicate that an alert state may occur within a future time period can be used to provide predictive notifications with the associated contextual information to a user or computing device. In one non-limiting example, such a contextual alerting system may be measuring the temperature of a freezer and identify a period of time where a characteristic temperature oscillation caused by a compressor may cease to exist. In such a case, a notification or message can be sent to a user indicating that the compressor may have stopped working and that a temperature increase (and the associated temperature alert) is likely to occur within the next few hours.

The embodiments herein described allow for inter alia determining, generating, and improving contextual notifications. Contextual notifications are messages which comprise associated information related to potential root causes of an alert, current state of a Process System, and/or recommendation for action to be taken in addition to simply indicating that an alert state is imminent, has been reached, or has been exited.

### Composite Classification Model

In certain embodiments, in order to provide the context related to an alert state, a classification model needs to be constructed. In order to build a classification model, the root cause states in Table 1 can be distilled into classes for classification and/or prediction. It would be inefficient to build a classification model for each root cause state. Instead, the root cause states can consist of a combination of classes. For example, in the last example in Table 1 above, the root cause state of “Door open multiple times. Compressor on, but struggling to lower temperature” is not a viable class for training because it is comprised of several more fundamental root causes. However, this composite root cause can be broken down into four primary root cause classes, where each primary class can be determined to be true or false: 1. “door open multiple times”=TRUE; 2. “compressor on”=TRUE; 3. “temperature normal”=FALSE; 4. “temperature decreasing”=TRUE.

Then each primary class can be predicted separately and combined as appropriate into a single contextual alert message. A preferred model will consist of the least number of primary classes as this will be the most accurate and efficient. Therefore, the goal is to reduce the entire root cause space into a matrix of primary classes. The first step is to identify the common and useful output status messages for a given Process System. It is preferable to identify most of the common and useful output status messages; it is more preferable to identify all of the possible output status messages. In this way, a composite model may be crated that is comprised of at least one primary model.

One non-limiting example of how to determine useful and common output status messages is to consider a list of questions that an end user would like answered by a status message. One ordinary skilled in the art will recognize that a user will likely have more questions during an alert state, but also that there may be instances where the user would want contextual notifications even when the Process System is not in an alert state (such as prior to an alert state when an alert state is predicted to occur, or during a period of normal operation where a user would like to receive periodic notifications informing him or her that the Process System is running correctly). Non-limiting examples of questions that a user may have for the non-limiting example of monitoring a freezer, refrigerator, or cold-storage apparatus are: Is the temperature ok?'; Is the compressor on?; Is the power out or freezer unplugged?; Is the compressor behaving abnormally?; Is the door currently open?; How many times has the door been opened recently?; Is the temperature currently increasing (getting worse) or decreasing (getting better) or stable (no change)? (i.e. what is the short-term temperature trend?); Has the temperature been increasing (getting worse) or decreasing (getting better) or stable (no change)? (i.e. what is the long term temperature trend?); Is the freezer currently being defrosted?

In this non-limiting example, a preferred goal of a contextual notification would be to answer all of the above questions, either explicitly or implicitly, at any given time. For instance, a message of “the freezer is operating normally” suggests the temp is ok, the compressor is on, the power is not out, the compressor is behaving normally, the door hasn't been opened excessively, the temperature is stable and we are not defrosting.

One ordinary skilled in the art will recognize that providing answers to at least one of the above questions would still be beneficial to the user. Furthermore, in the case where none of the questions above could be answered confidently, it would still be beneficial to inform the user that in fact none of questions can be confidently answered. This is because such a message would allow the user to conclude that a new, unknown root cause may be manifesting. Table 2 below shows examples of seven root cause class groups, and the corresponding class labels.

TABLE 2
Class Groups and Class Labels

| Class Group | Class Labels |
|---|---|
| Door Open History | (none, one extended, many) or |
| | alternatively (typical, atypical) |
| Current Door Open Status | closed, open |
| Temp Trend Short Term | Increasing, Decreasing, Stable |
| Temp Trend Long Term | Increasing, Decreasing, Stable |
| Compressor Status | cycling, not cycling |
| Temperature status | high, low, normal |
| Defrosting | (yes, no) or possibly |
| | a combination of above states |

Note that “unknown” is the default class label for every class group.

In this example, by considering each class group separately and creating models for each class group, the number of models is kept to a smaller number. The “Door Open History” model would only require 2 classes to be predicted (if the labels were to be “typical” and “atypical”) or 3 classes to be predicted (if the labels were “none”, “one extended”, and “many”). Similarly, the “Current Door Open Status” model would require only two classes to be predicted (“closed” or “open”). In total there are 7 class groups, which suggests 7 different models will need to be trained, one for each class group. In this non-limiting example, however, each model has at most 3 output class labels (plus the default unknown class label), which will lower the training time, keep the models small, and hopefully allow for ample training samples for each class. If however, one model was created to combine all of the above class groups and labels, there would be over 400 classes to predict, one for each combination of all classes for each class group. Realistically this may be unfeasible for practical applications where the size of a training set may be limited.

Thus, according to further embodiments the present invention provides methods of creating composite root cause messages based on classification of primary root causes which then are subsequently combined together.

### Model Building Example

One ordinary skilled in the art will recognize that there are many different approaches to building classification models. This is well known in the fields of artificial intelligence and machine learning (often referred to as AI/ML). There are generally two broad methods of constructing models in the field of AI/ML: supervised learning models and unsupervised learning models.

One ordinary skilled in the art will recognize that there are several methods of AI/ML including but not limited to the following:
1. Supervised learning is the machine learning task of learning a function that maps an input to an output based on example input-output pairs. It infers a function from labeled training data consisting of a set of training examples. In supervised learning, each example is a pair consisting of an input object (typically a vector) and a desired output value. See https://en.wikipedia.org/wiki/Supervised_learning (Wikipedia last accessed on 18 Sep. 2020.
2. Unsupervised learning is a type of machine learning that looks for previously undetected patterns in a data set with no pre-existing labels and with a minimum of human supervision. In contrast to supervised learning that usually makes use of human-labeled data, unsupervised learning, also known as self-organization allows for modeling of probability densities over inputs. It forms one of the three main categories of machine learning, along with supervised and reinforcement learning. See https://en.wikipedia.org/wiki/Unsupervised_learning (Wikipedia on 18 Sep. 2020)
3. Semi-supervised learning, a related variant, makes use of supervised and unsupervised techniques. It is an approach to machine learning that combines a small amount of labeled data with a large amount of unlabeled data during training. Semi-supervised learning falls between unsupervised learning (with no labeled training data) and supervised learning (with only labeled training data). See https://en.wikipedia.org/wiki/Semi-supervised_learning (Wikipedia last accessed on 18 Sep. 2020).
4. Weakly supervised learning is a branch of machine learning where noisy, limited, or imprecise sources are used to provide supervision signal for labeling large amounts of training data in a supervised learning setting. This approach alleviates the burden of obtaining hand-labeled data sets, which can be costly or impractical. Instead, inexpensive weak labels are employed with the understanding that they are imperfect, but can nonetheless be used to create a strong predictive model. See https://en.wikipedia.org/wiki/Weak_supervision (Wikipedia last accessed on 18 Sep. 2020).

### Developing a Weakly-Supervised Model

In this non-limiting example, a freezer status algorithm will be developed using a weak supervision framework. In weak supervision, rules are handcrafted by domain experts which are used to label training data instead of manual inspection. Each rule labels a training example with a class or abstains from labeling. For example: “if temperature >20C for past 1 hr then defrosting=yes; else no”; and/or “if temperature is decreasing then compressor=cycling; else abstain”.

These rules can be noisy by nature and can contradict each other. Multiple rules are written for each class group until every example has at least one label (i.e. at least one rule does not abstain for each example). Next, the hand-crafted rules are weighted based on a likelihood function, which ultimately gives higher weight to rules that tend to agree with other rules. The re-weighted rules are then used to give a final class label to each example. These weighted labels are then used to train a machine learning model. This method drastically reduces the need for hand labeled data, increasing development speed and thereby reducing effort, cost, and time.

A small development training/test data set is necessary. The training set is used to help craft the rules, the test set is used to validate the final model. The model building and testing process is done completely independently of the hand labeled data.

### Programmed Rules Example to Determine if Compressor is On or Off

To show the feasibility of using programmed rules for this application, a single freezer was investigated. Five rules were initially crafted to classify whether the compressor was on or off based on the temperature readings over a period of time. After running the rules over a data set at one hour intervals, three of the rules had values that had discriminating value. These three rules are as follows: 1. If the temperature range <10 degrees then compressor is on (+1), compressor is off (−1); 2. Split the time series data into 5 windows of equal size. If the resonant frequency of the most recent split is >double the median, then the compressor is off (−1), else compressor is on (+1); and/or 3. Split the time series data into 5 windows of equal size. If the resonant frequency of the most recent split is >double the minimum, then the compressor is off (−1), else compressor is on (+1)

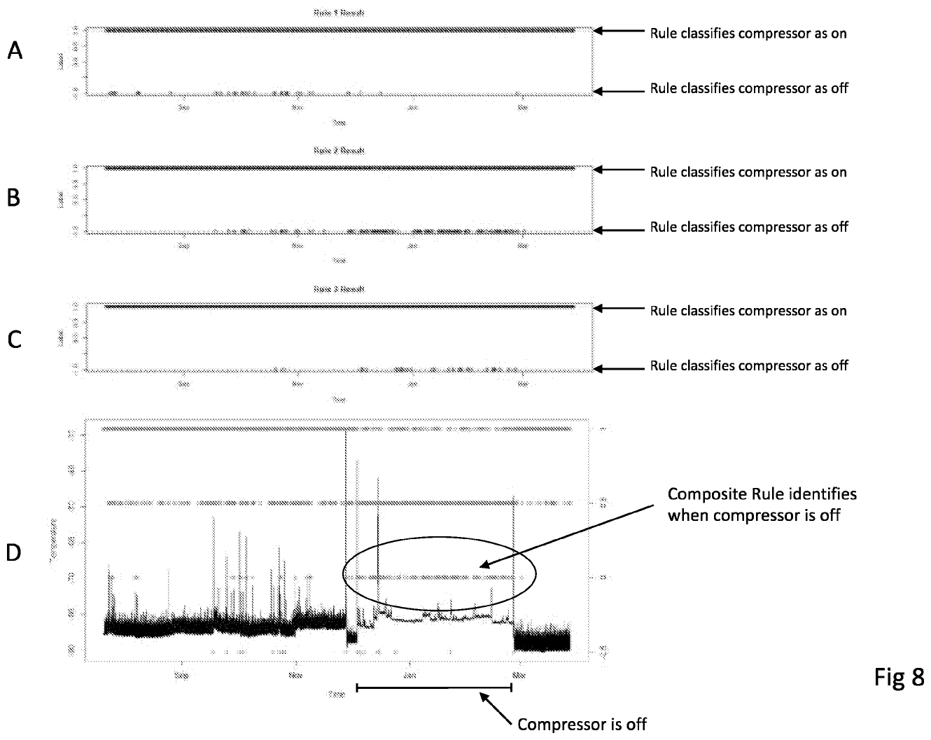

Rule 1. identifies positive events, i.e. compressor is cycling. Rules 2 and 3 identify negative events i.e. compressor is not cycling. FIG. 8 shows how these rules were tested on data from a freezer: FIG. 8D is the raw temperature data over a period of approximately 9 months; FIG. 8A is the output of the classifier of Rule 1. A value of +1 during a given 1-hour time window means that the model classified the compressor state as being on. A value of −1 during a given 1-hour time window means that the model classified the compressor state as being on; FIG. 8B is the output of the classifier of Rule 2. A value of +1 during a given 1-hour time window means that the model classified the compressor state as being on. A value of −1 during a given 1-hour time window means that the model classified the compressor state as being on; FIG. 8C is the output of the classifier of Rule 3. A value of +1 during a given 1-hour time window means that the model classified the compressor state as being on. A value of −1 during a given 1-hour time window means that the model classified the compressor state as being on.

It is clear from these three rules taken independently that there is a significant number of false positives. As can be seen from the raw data of FIG. 8D, there is clearly one long period of time (between approximately December to late February) where the compressor is seen to be off. This can be seen visually since there is no characteristic oscillation of the temperature as is seen in other time periods. This type of performance is expected using weak supervision since the training data is often noisy and sparse. The goal however is to craft enough rules with high enough accuracy that when combined they give a relatively accurate label.

When the three rules are combined into a composite rule, the performance of the model can be improved. One ordinary skilled in the art will recognize that there are many methods of combining the models, including but not limited to averaging the values of each rule's output or using logistic regression. In this example, logistic regression was used. The red dots in FIG. 8D are the output of the combined model.

In this example, the combined model's output can be interpreted as follows: a value >0 suggests that the compressor is on; the higher the model's output, the higher the confidence that the compressor is off; and/or a value <=0 suggests that the compressor is off; the lower the model's output the higher the confidence that the compressor is off

It is clear that the label noise is improving. There are still several false positives (red dots above 0 during the period where the compressor is off), but these false positives are likely due to door opening events that were not accounted for in these rules. However, the important output is that the long band of no compressor activity is clearly tagged with many negative results. Thus, one can trigger a notification based on the composite rule outputting values <=0 to inform a user that the compressor may not be on or functioning properly.

### Mapping Root Cause to External Messages

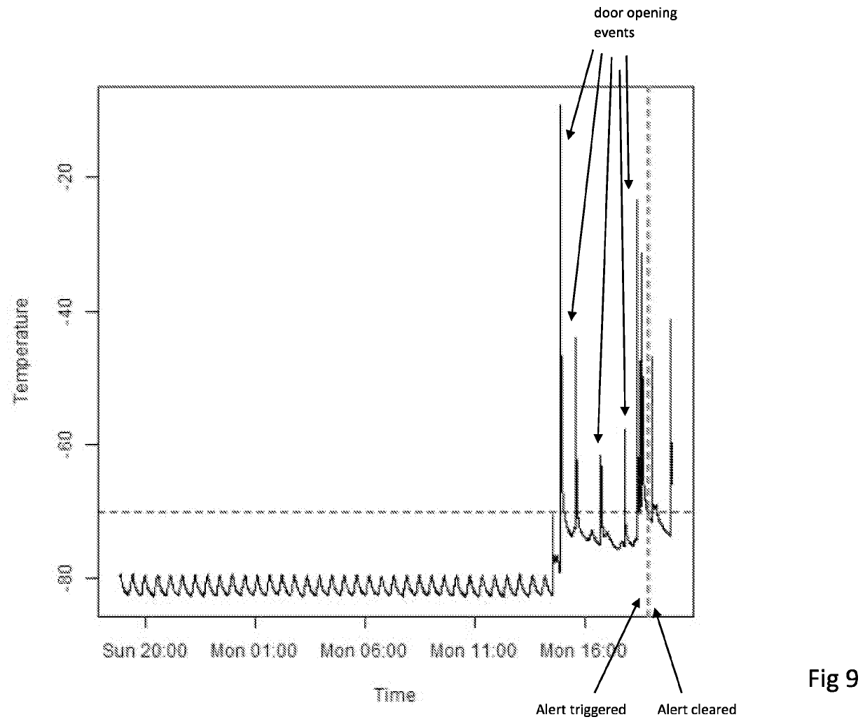

As described above, it is often the case that to provide an explanation for why a Process System is in an alert state (or might be approaching an alert state), there may be several factors that contribute to the cause. In such a situation, it is convenient to create a composite root cause comprised of at least one primary root cause. In this manner, the combination of several primary root causes into a composite root cause can be mapped to an external message that is suitable for a human user, or even another machine, to understand. FIG. 9 and Table 3A show an example of combining the predictions of several class groups together to map to one external message.

TABLE 3A
External message example 1

| | | Predicted | |
|---|---|---|---|
| Figure | Class Group | Class | External Message |
| FIG. 9 | Door Open | many | The temperature is above |
| | History | | threshold. It appears the door |
| | Current Door | closed | has been opened several times. |
| | Open Status | | The door is currently |
| | Temp Trend | Decreasing | closed and the |
| | Short Term | | temperature is |
| | Temp Trend | Stable | decreasing. |
| | Long Term | | |
| | Compressor | unknown | |
| | Status | | |
| | Temperature | high | |
| | status | | |
| | Defrosting | no | |

In FIG. 9, the freezer door has been opened several times during a relatively short period of time. The door opening events are seen as “spikes” in the temperature reading. In this example, the freezer's compressor has not had enough time to stably fall below the alert threshold (shown as the horizontal dotted line). An alert is triggered (red vertical dotted line) when the temperature has remained above the threshold for some pre-determined amount of time. Then, soon afterwards, the alert is cleared (e.g. A notification is sent to the user indicating that the freezer is no longer in the alert state)—this is shown by the green vertical dotted line. However, the external message that can be sent to the user (see Table 3A) provides context as to why the alert may have been triggered in the first place, namely that “The temperature is above threshold. It appears the door has been opened several times. The door is currently closed and the temperature is decreasing”.

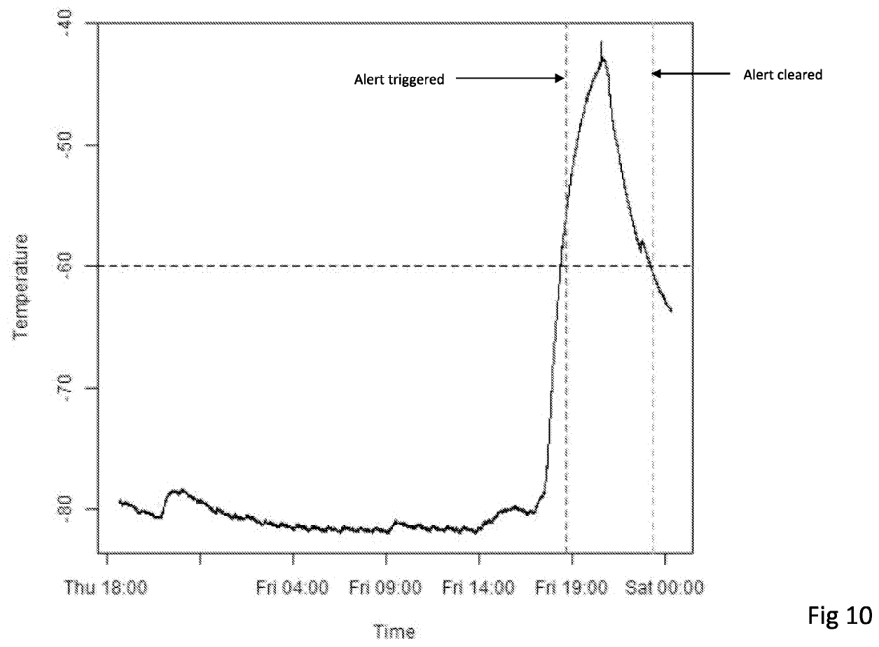

FIG. 10 and Tables 3B and 3C show another example where two different external message can be composed—one at the start of an alert state when it is triggered, and one at the end of the alert state when it is cleared.

TABLE 3b
External Message Example 2

| | | Predicted | |
|---|---|---|---|
| | | Class | |
| Example | Class Group | (Red Line) | External Message |
| FIG. | Door Open | none | The temperature is above |
| 10 | History | | threshold. It appears that |
| | Current Door Open | closed | the compressor is off. |
| | Status | | The door is currently |
| | Temp Trend Short | increasing | closed and the |
| | Term | | temperature is |
| | Temp Trend Long | Stable | increasing. |
| | Term | | |
| | Compressor Status | off | |
| | Temperature status | high | |
| | Defrosting | no | |

TABLE 3c
External Message Example 3 - Status is improving,
but temperature is still above threshold

| | | Predicted Class | |
|---|---|---|---|
| | | (Just Prior to | |
| Example | Class Group | Green Line) | External Message |
| FIG. 10 | Door Open History | none | The temperature is |
| | Current Door Open | closed | above threshold. |
| | Status | | It appears that |
| | Temp Trend Short | Decreasing | the compressor |
| | Term | | is on. The door |
| | Temp Trend Long | Stable | is currently |
| | Term | | closed and the |
| | Compressor Status | on | temperature |
| | Temperature status | high | is decreasing. |
| | Defrosting | no | |

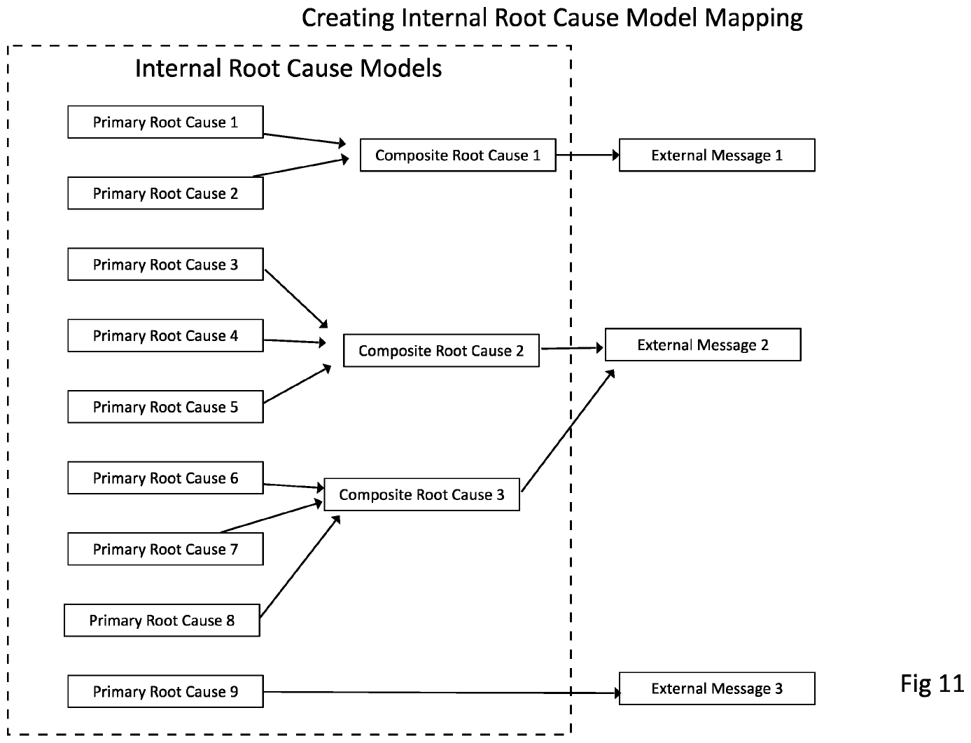

FIG. 11 generalized this concept. Internal root cause models are comprised of at least one of a primary root cause model and/or a composite root cause model. Each primary root cause is the predicted class of a given class group. The composite root cause is the combination of the relevant primary root causes, which then get mapped to an external message. As can be seen in this non-limiting example, a primary root cause may be mapped directly to an external message or more than one composite root cause may be mapped to one external message.

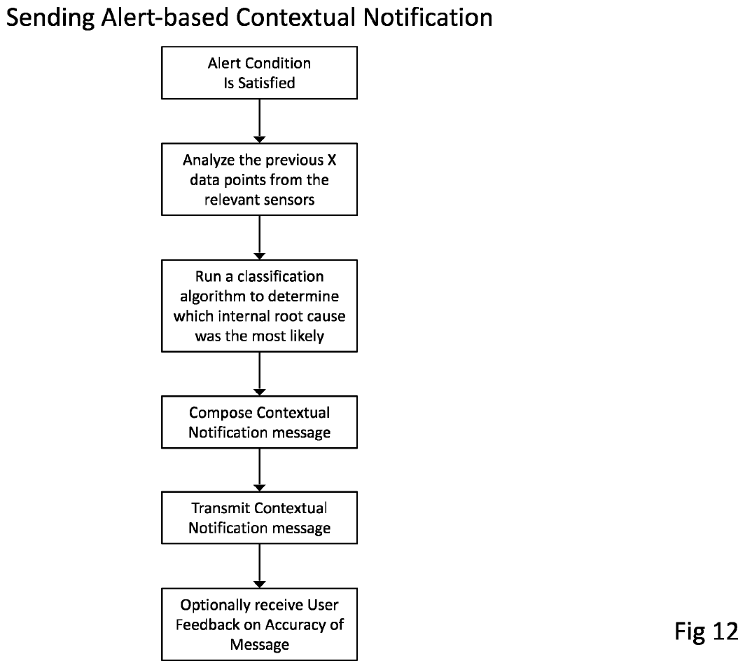

FIG. 12 shows a generalized method for sending alert-based contextual notifications of the invention. In this example method, a rules-based alert condition is first satisfied (for example, a threshold-based alert). Once that alert is triggered, then the data leading up to that alert is analyzed, then the relevant classification models are run to identify the primary root causes and the composite root cause. Then an appropriate message is either composed or selected from a set of predetermined messages, which is then transmitted to a user. Optionally, the user may be prompted to confirm whether the message was accurate in classifying the primary root causes and/or the composite root cause. In this manner, the feedback from the user can be used to improve the machine learning model through reinforcement learning and other techniques that are known to one averagely skilled in the art.

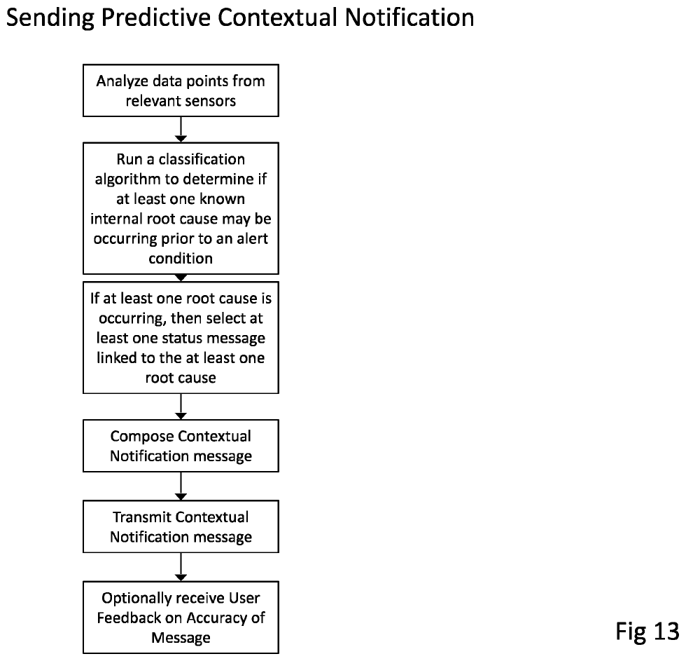

FIG. 13 shows how a method embodiment of the present invention can be used in a proactive manner to predict that an alert state may be occurring. In this example, the classification model is run either continually, or at regular, periodic, or aperiodic time intervals and is not run exclusively only after an alert has been triggered. In this manner, when the classification model is able to identify at least one internal root cause (whether it is a primary root cause or a composite root cause), an appropriate message can be sent to the user to notify them that conditions are present that may cause the Process System to enter into an alert state in the near future. Thus, the invention may also be used for predicting alert states like machine failures. Also, optionally, the user may be prompted to confirm whether the message was accurate in classifying the primary root causes and/or the composite root cause and/or predicting that an alert state was about to be triggered. In this manner, the feedback from the user can be used to improve the machine learning model through reinforcement learning and other techniques that are known to one averagely skilled in the art.

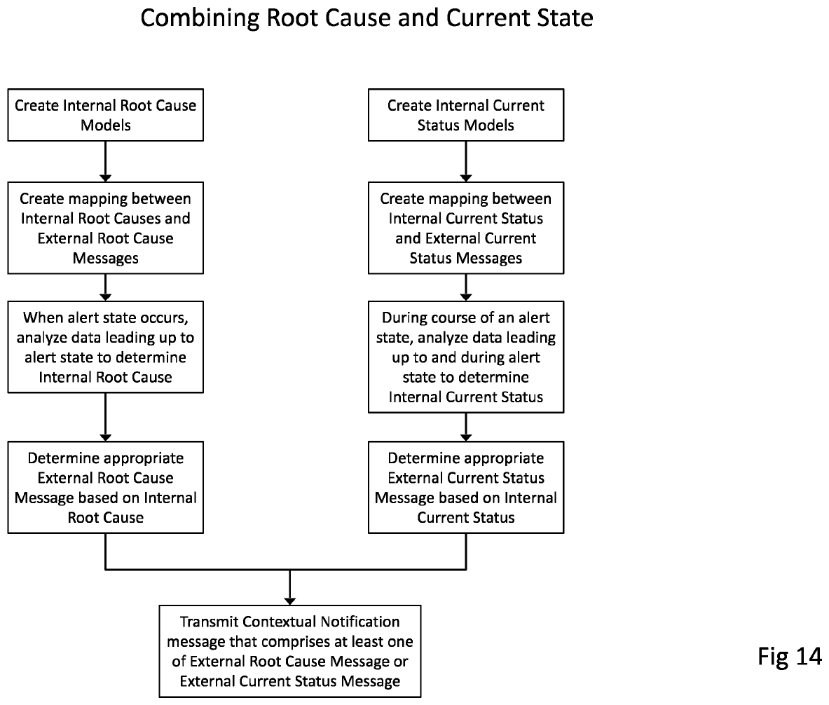

FIG. 14 shows another example embodiment of the invention where an external message may be mapped to either/or an internal root cause that is determined when an alert state occurs and/or such an external message may be mapped to the current state of the Process System while it is in an alert state. One example is to transmit a message while a freezer is above a threshold (and is thus in the alert state) and inform the user that even though it is an alert state, the temperature is decreasing towards the normal desired range. This the contextual message here is related to its current state (temperature decreasing) and not just to the conditions leading up to the alert.

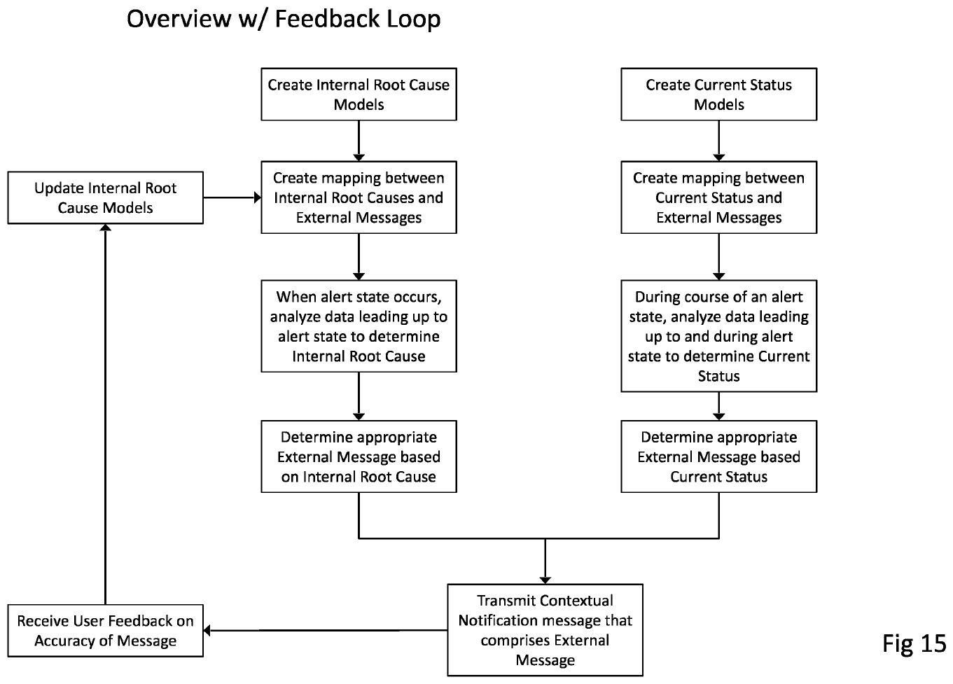

FIG. 15 extends the example of FIG. 14 and provides a user feedback loop. The user may be prompted to confirm whether the message accurately reflected the Internal root cause and/or the current status of the Process System. One averagely skilled in the art will recognize that such feedback may be automatically fed back into the model to improve its performance and accuracy over time. One example of this is called reinforcement learning.

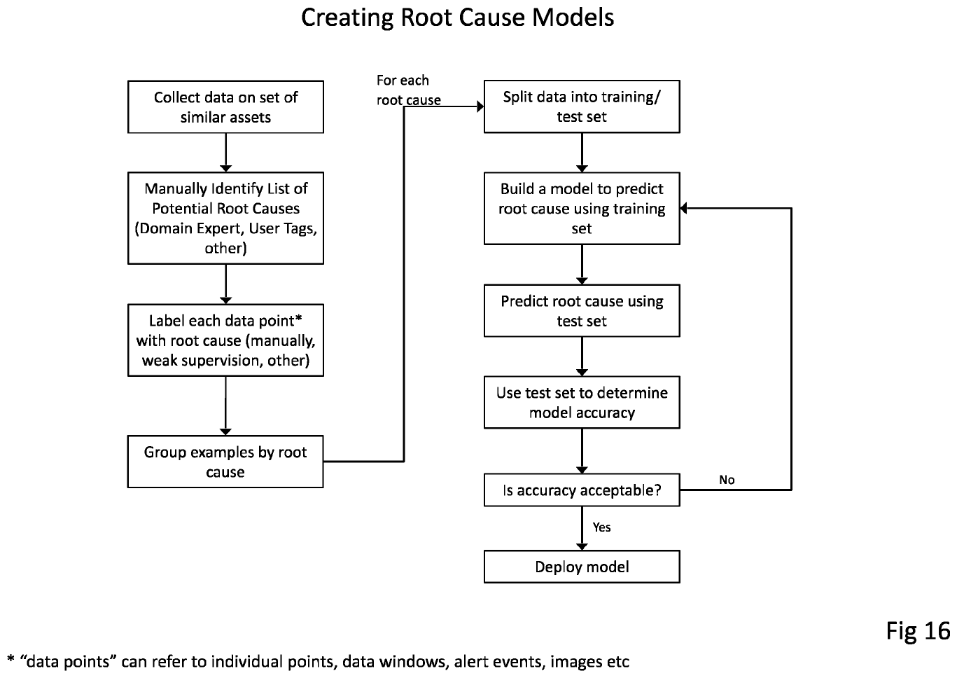

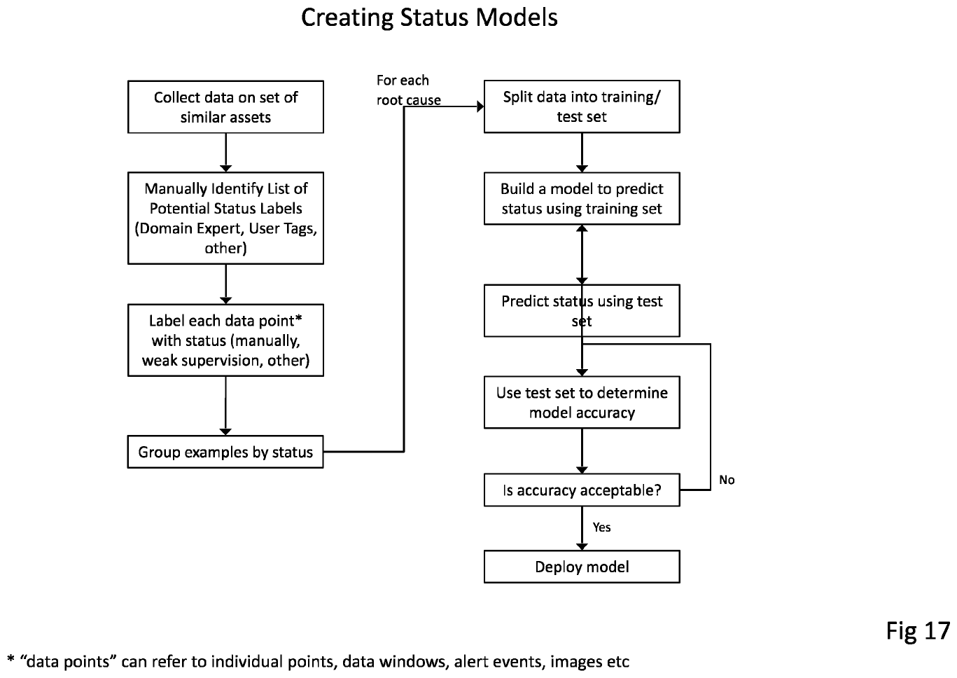

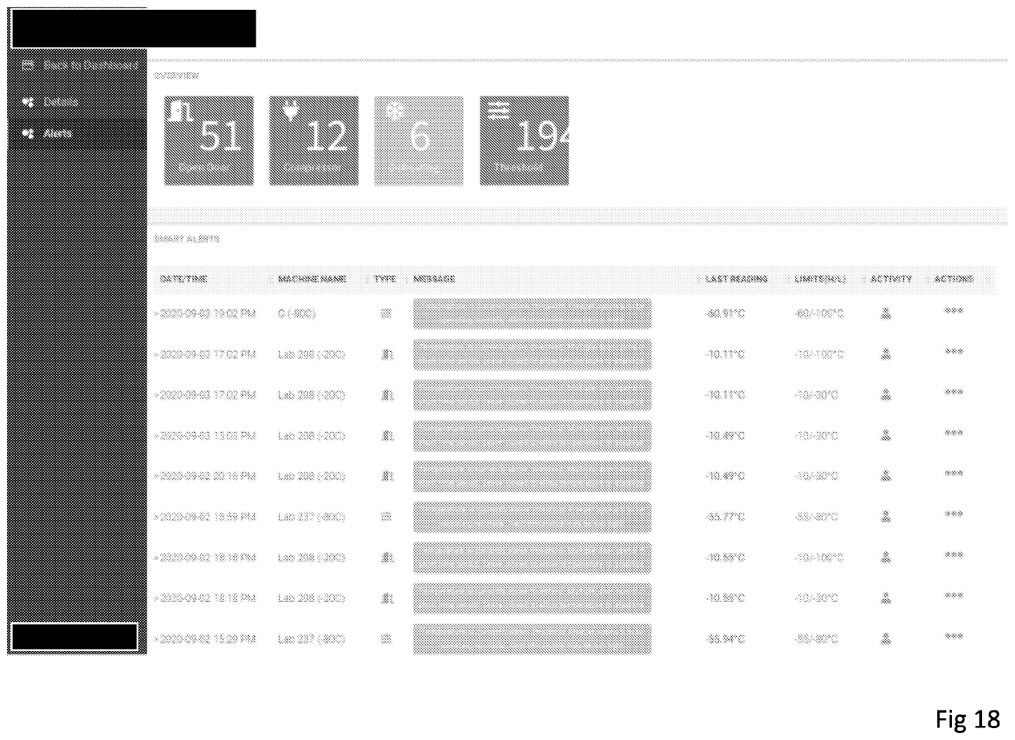

FIG. 16 shows one example embodiment of the invention for a method to create root cause models. FIG. 17 shows one example embodiment of the invention for a method to create status models. FIG. 18 shows an example embodiment for how contextual notifications can be displayed to a user. In this example, a web application dashboard is used and a message column is displayed with the contextual information related to the alert.

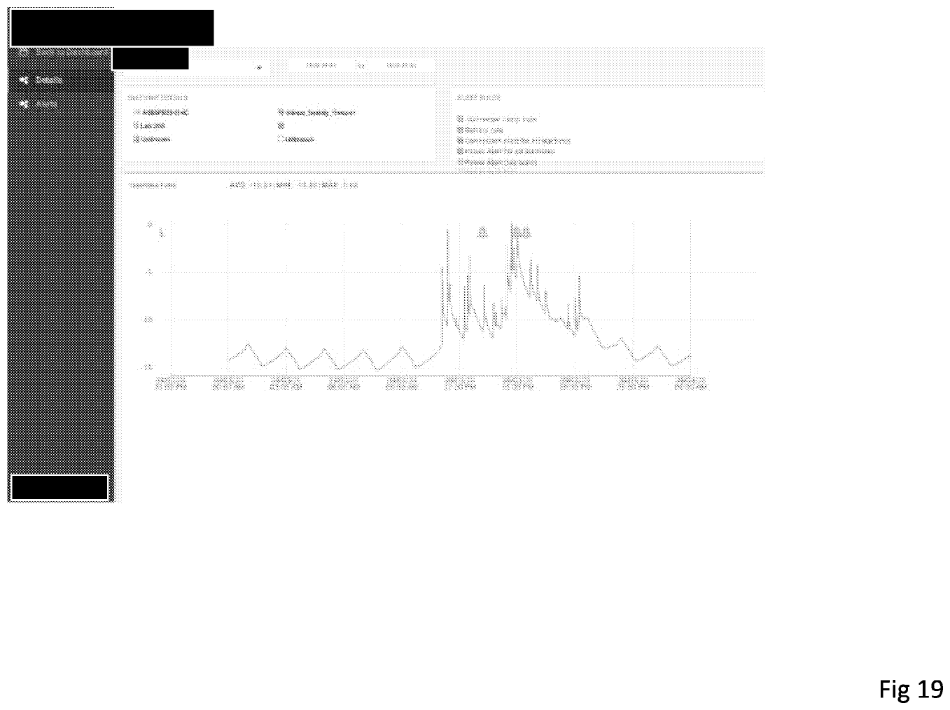

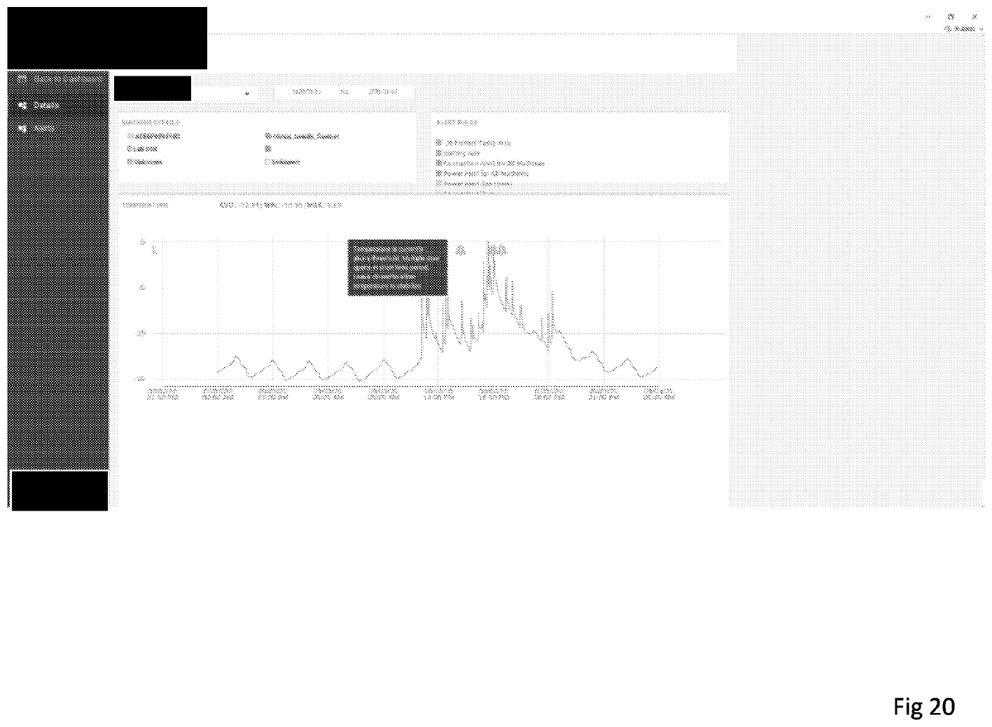

FIG. 19 shows temperature data displayed in a dashboard. Where there is an alert, there is a bell icon that is displayed at that time period. When the user clicks or hovers over the bell icon, the contextual message can be displayed as a pop up as shown in FIG. 20.

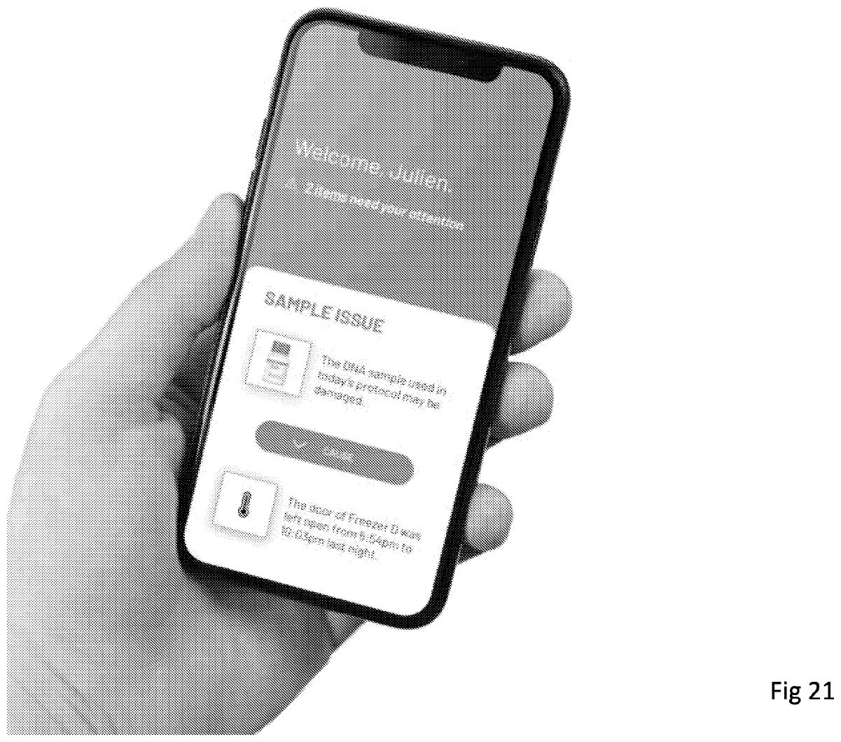

FIG. 21 shows an example of how contextual notifications can be conveyed to a user via different types of media and user interfaces. It shows how data can be combined from multiple sensors and/or data sources to create a message that is composed of two distinct pieces of information: (1) The user is using a particular DNA sample whose storage location is known. This can be pulled from an ELN (Electronic Lab Notebook) or LIMS (Laboratory Information Management System), or equivalent, or it can be manually entered by the user; and/or (2) The door of the freezer where the user's DNA sample was stored had its door open the previous night and therefore the sample may be damaged.

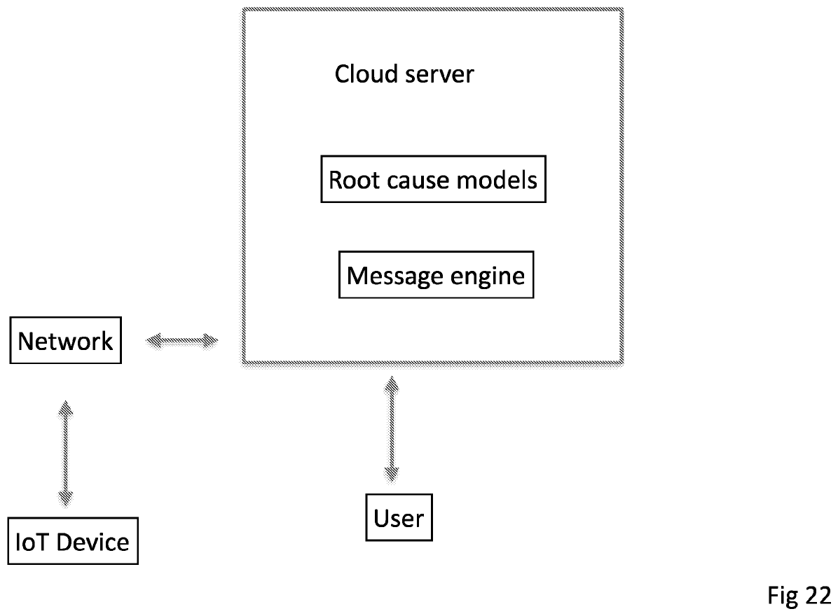

FIG. 22 shows a basic diagram of a system that embodies the invention, wherein an IoT device can be remotely connected to a cloud server through a local network. The cloud server can run the root cause models and analysis described above and associated messaging engine and provide said contextual alerts and notification to remote user, etc. Unless the context is specifically limiting the terms analytical instrument, measurement instrument, laboratory instrument, process instrument, manufacturing instrument, analytical equipment, measurement equipment, laboratory equipment, process equipment, manufacturing equipment, testing instrument/equipment, medical instrument/equipment, and facility management instrument/equipment, etc. are used interchangeably herein. These instruments and equipment are well known in the art and are not particularly limited herein.

Incorporated herein by reference are U.S. Prov. Application Ser. No. 62/739,427 filed on Oct. 1, 2018; U.S. application Ser. Nos. 16/589,347 and 16/589,713 filed on Oct. 1, 2019; and PCT Application Serial Nos. PCT/2019/53941 and PCT/2019/53977 filed on Oct. 1, 2019; US Prov. Applications entitled (1) “Method and Apparatus for Local Sensing” which was filed on Oct. 1, 2018 and received U.S. Provisional Application Ser. No. 62/739,419 and its related PCT application Ser. No. PCT/US19/54020; (2) “Method and Apparatus for Process Optimization” which was filed on Oct. 1, 2018 and received U.S. Provisional Application Ser. No. 62/739,441 and “Method and Apparatus for Process Optimization” which was filed on Feb. 4, 2019 and received U.S. Provisional Application Ser. No. 62/800,900 and their related US and PCT applications (U.S. Ser. No. 16/589,713 and PCT/US19/53977). These applications are incorporated in their entireties herein by reference for all purposes.

Any external reference mentioned herein, including for example websites, articles, reference books, textbooks, granted patents, and patent applications are incorporated in their entireties herein by reference for all purposes.

Reference throughout the specification to “one embodiment,” “another embodiment,” “an embodiment,” “some embodiments,” and so forth, means that a particular element (e.g., feature, structure, property, and/or characteristic) described in connection with the embodiment is included in at least one embodiment described herein, and may or may not be present in other embodiments. In addition, it is to be understood that the described element(s) may be combined in any suitable manner in the various embodiments.

Numerical values in the specification and claims of this application reflect average values for a composition. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

1. A method for determining, generating, and issuing a contextual alert message to a user regarding an alert condition of a process system, the method comprising the steps of:
(i) determining variable data from a sensor associated with a process system;
(ii) transmitting a first set of variable data from the sensor to a server and using the server to develop an alert classification model using the first set of variable data, wherein the alert classification model contains contextual information about an alert condition of the process system;
(iii) transmitting a second set of data from the sensor to the server and using the server to compare the second set of data to a threshold value to determine if the process system is in an alert condition or approaching an alert condition;
wherein if the process system is determined in step (iii) to be in an alert condition or approaching an alert condition, then:
(iv) using the server to compare the second set of data to the alert classification model to determine contextual information about the alert condition of the process system; and
(v) using the server to generate and issue a contextual alert message to a user regarding the alert condition of the process system,
thereby determining, generating, and issuing a contextual alert message to a user regarding an alert condition of a process system.

2. The method of claim 1, wherein the contextual alert information comprises the alert condition and contextual information about the alert condition selected from the group consisting of: why/when/how the alert condition was/will be reached; the root cause/timing of the alert condition; whether the process system is currently in/out of the alert condition; the current variable data of sensor measurement; the trajectory of the variable data; and data or information received or interpreted from other sensors,
or wherein the contextual alert information comprises a root cause message based on classification of primary root causes of process systems alerts and current process conditions which then are subsequently combined together.

3. The method of claim 1, wherein variable data is received and used by the server from a second sensor, in developing the alert classification model and in determining the contextual information about the alert condition.

4. The method of claim 1, wherein the contextual alert message is a predictive contextual alert message.

5. The method of claim 4, wherein the predictive contextual alert message contains prediction information regarding a future alert condition of the process system or that the process system is on a trajectory to achieve and/or is approaching a future alert condition.

6. The method of claim 1, wherein the process system is located in a facility selected from the group consisting of: a laboratory, medical facility, and a manufacturing facility.

7. The method of claim 1, wherein the sensor associated with the process system is an environmental variable sensor positioned to determine variable environmental data about or within the process system.

8. A method for determining and generating a contextual alert message regarding an alert condition of a process system, the method comprising the steps of:
(i) using variable data from a sensor associated with a process system to develop an alert classification model that contains contextual information about an alert condition of the process system;
(ii) using variable data from the sensor if the process system is in an alert condition;
wherein if the process system is determined in step (ii) to be in an alert condition, then:
(iii) comparing the variable data received in step (ii) to the alert classification model developed in step (i) to determine contextual information about the alert condition of the process system; and
(v) generating a contextual alert message regarding the alert condition of the process system,
thereby determining and generating a contextual alert message regarding an alert condition of a process system.

9. The method of claim 8, wherein variable data is received and used from a plurality of sensors, in developing the alert classification model and in determining the contextual information about the alert condition.

10. The method of claim 8, wherein step (ii) further comprises the step of transmitting a user response and/or input to the server regarding the first set of data and/or accuracy of the contextual alert issued message generated in step (v), and using the user responses and/or input by the server in the development of the alert classification model.

11. The method of claim 10, wherein the user response or input comprises data/alert rules, data labels, and/or data/alert classification.

12. The method of claim 8, wherein the contextual alert information comprises the alert condition and contextual information about the alert condition selected from the group consisting of: why/when/how the alert condition was/will be reached; the root cause/timing of the alert condition; whether the process system is currently in/out of the alert condition; the current variable data of sensor measurement; the trajectory of the variable data; and data or information received or interpreted from other sensors,
or wherein the contextual alert information comprises a root cause message based on classification of primary root causes of process systems alerts and current process conditions which then are subsequently combined together.

13. The method of claim 8, wherein the contextual alert message is a predictive contextual alert message.

14. The method of claim 13, wherein the predictive contextual alert message contains prediction information regarding a future alert condition of the process system or that the process system is on a trajectory to achieve and/or is approaching a future alert condition.

15. The method of claim 8, wherein the process system is located in a facility selected from the group consisting of: a laboratory, medical facility, and a manufacturing facility.

16. The method of claim 8, wherein the sensor associated with the process system is an environmental variable sensor positioned to determine variable environmental data about or within the process system.

17. An apparatus for determining and generating and/or issuing a predictive contextual alert message to a user regarding a predicted alert condition of a process system, the apparatus comprising programmed circuitry comprising instructions for performing the steps of claim 8.

18. An apparatus for determining and generating and/or issuing a predictive contextual alert message to a user regarding a predicted alert condition of a process system, the apparatus comprising programmed circuitry comprising instructions for performing the steps of claim 1.
